(19) United States
(12) Patent Application Publication
(10) Pub. No.: US 2007/0211884 A1
(43) Pub. Date: Sep. 13, 2007

(54) Privacy protection method for terminal subscriber, privacy protection terminal device, and privacy protection program

(75) Inventors: Yoshitomo Ishii, Kawasaki (JP); Katsuaki Akama, Kawasaki (JP); Osamu Hamaue, Kawasaki (JP); Toshikazu Houmura, Kawasaki (JP); Masanobu Kanazawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/494,460

(22) Filed: Jul. 28, 2006

(30) Foreign Application Priority Data
Mar. 9, 2006 (JP) 2006-064261

(51) Int. Cl. H04M 1/00; H04M 3/00

(52) U.S. Cl. 379/355.04

(57) ABSTRACT

A privacy protection method for a terminal subscriber and a terminal and program for implementing the same are provided, wherein at least either a picture or voice associated with at least either an individual or an organization registered in an address book is preregistered in a terminal equipped with a function that enables the terminal to be switched between a privacy mode and a non-privacy mode, and wherein when a call arrives at the terminal in the privacy mode, processing is performed at least either to display an image or to reproduce voice with which a caller cannot be identified, instead of displaying the picture or reproducing the voice registered in the address book, while when a call arrives at the terminal in the non-privacy mode, processing is performed at least either to display the picture or to reproduce the voice registered in the address book, thereby preventing the pictures, etc. preregistered in the terminal from being unrestrictedly presented for display for viewing by other persons, and thus protecting the privacy of the terminal subscriber.

### TECHNICAL FIELD

The present invention relates to a privacy protection method for a terminal subscriber, a privacy protection terminal device, and a privacy protection program, and more particularly to a privacy protection method for a portable terminal subscriber and a terminal device and program for implementing the same.

### BACKGROUND ART

To facilitate the identification of the calling party or for personal fun, some of recent portable terminals are equipped with functions to store pictures and/or voice associated with organizations or individuals registered in address books.

According to such portable terminals, when a call arrives from a person registered in the address book, a picture, etc. of the caller may be displayed on the portable terminal of the called party without any restrictions.

[Patent Document 1] Japanese Unexamined Patent Publication No. 2001-24776

[Patent Document 2] Japanese Unexamined Patent Publication No. 2005-50012

### DISCLOSURE OF THE INVENTION

### PROBLEM TO BE SOLVED BY THE INVENTION

As a result, when, for example, an incoming call arrives at the portable terminal while the portable terminal subscriber is away from it, and a third party, i.e., a person other than the portable terminal subscriber, answers the call by taking that portable terminal off-hook, the third party sees the picture, etc. of the caller registered in the address book. This does not present any problem as long as the terminal subscriber does not care if the picture, etc. may be seen by other persons; however, if, for example, the terminal subscriber does not want to reveal his business customers or his friend to other persons, there arises a problem in terms of privacy protection.

Such a problem is not limited to the case of wireless mobile terminals such as portable terminals, but a similar problem can occur in the case of other terminals such as wired telephones and personal computers.

In view of the above prior art problem, it is an object of the present invention to provide a privacy protection method for a terminal subscriber, a privacy protection terminal device, and a privacy protection program, wherein provisions are made to protect the privacy of the terminal subscriber by equipping the terminal with a privacy mode and a non-privacy mode and by allowing pictures, etc. stored in the address book to be displayed at the time of call arrival only in the non-privacy mode, thereby preventing the pictures, etc. stored in the terminal from being unrestrictedly presented for display for viewing by other persons.

### MEANS FOR SOLVING THE PROBLEM

To achieve the above object, according to a first mode of the present invention, there is provided a privacy protection method for a terminal subscriber, comprising: preregistering at least either a picture or voice associated with at least either an individual or an organization registered in an address book in a terminal equipped with a function that enables the terminal to be switched between a privacy mode and a non-privacy mode; when a call arrives at the terminal in the privacy mode, performing processing at least either to display an image or to reproduce voice with which a caller cannot be identified, instead of displaying the picture or reproducing the voice registered in the address book; and when a call arrives at the terminal in the non-privacy mode, performing processing at least either to display the picture or to reproduce the voice registered in the address book.

According to a second mode of the present invention, the first mode further comprises: determining, in the case of the non-privacy mode, at which of at least two levels the non-privacy mode is; and performing processing at least either to display the picture or to reproduce the voice preregistered in the address book in accordance with the determined level of the non-privacy mode.

According to a third mode of the present invention, there is provided a privacy protection terminal device and privacy protection program for implementing the method of the first mode.

### EFFECT OF THE INVENTION

According to the present invention, as the picture or voice associated with any calling party registered in the address book is displayed at the time of call arrival from the calling party only when the terminal is set in the non-privacy mode, the privacy of the terminal holder can be protected by setting the terminal in the privacy mode and preventing the picture or voice associated with any individual or organization registered in the address book of the subscriber from being seen or heard by a third party.

### BRIEF DESCRIPTION OF THE DRAWINGS

FIG. 1 is a flowchart for explaining a privacy protection method according to one embodiment of the present invention;

FIG. 2 is an external view of a portable telephone implementing the privacy protection method according to the one embodiment of the present invention; and

FIG. 3 is a block diagram showing the configuration of a privacy protection terminal device according to another embodiment of the present invention.

### BEST MODE FOR CARRYING OUT THE INVENTION

Embodiments of the present invention will be described below with reference to the drawings.

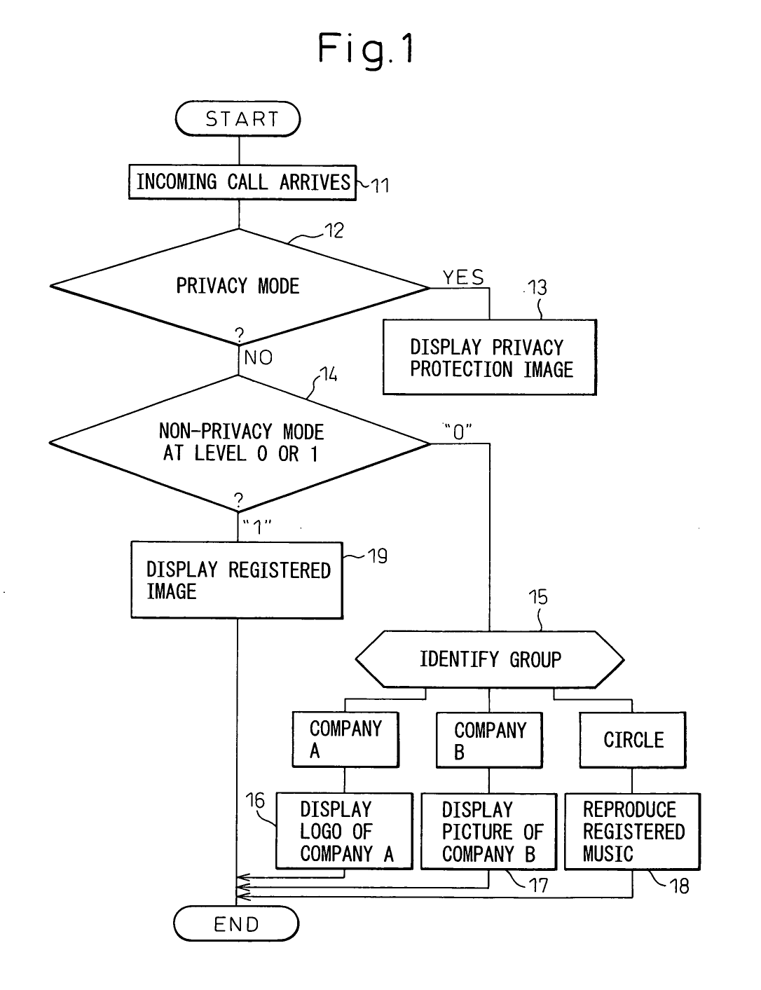

FIG. 1 is a flowchart for explaining a privacy protection method according to one embodiment of the present invention. Software for implementing this flowchart is either built into the portable terminal or downloaded from the software provider into the existing portable terminal over the Internet via a wired or wireless link. In the figure, when an incoming call arrives at the portable terminal in step 11, the software is activated in step 12 to check whether the portable terminal is set in a privacy mode or not. If it is set in the privacy mode, a privacy protection screen is displayed in step 13. Any image with which the caller cannot be identified, for example, an image of a landscape or an image of a flower, can be used for display on the privacy protection screen. With this arrangement, if the portable terminal subscriber inadvertently leaves his portable terminal somewhere, if a third party, a person other than the portable terminal subscriber, answers the incoming call, the third party cannot instantly identify who the caller is from the image display on the portable terminal, and thus the privacy of the portable terminal subscriber is protected.

If it is determined in step 12 that the portable terminal is in a non-privacy mode, the process proceeds to step 14 to check if the non-privacy mode is at level 0 or level 1. If it is at level 0, the non-privacy mode allows the identification of the caller to be revealed to a certain extent, and the process proceeds to step 15 to judge which group in the address book the caller belongs to; then, processing is performed such as displaying the logo mark of company A in step 16 if the caller belongs to company A, or displaying the picture of company B in step 17 if the caller belongs to company B, or reproducing preregistered music associated with a particular circle if the caller is a member of that particular circle.

If it is determined in step 14 that the non-privacy mode is at level 1, since the non-privacy mode at this level is an unrestricted non-privacy mode, the image preregistered in the address book is displayed in step 19. The preregistered image may be a picture of the caller's face or some other image with which the caller can be identified. Voice or music that can identify the caller may be reproduced together with or instead of the image.

The number of levels of the non-privacy mode may be increased, or only one level may be used.

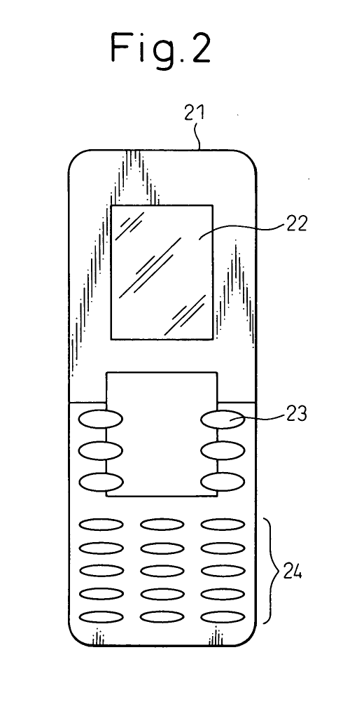

FIG. 2 is an external view of a portable telephone implementing the privacy protection method according to the one embodiment of the present invention. In the figure, reference numeral 21 is the portable telephone, 22 is a display screen, 23 is a selector button for selecting between the privacy mode and the non-privacy mode according to the present invention, and 24 is a numeric key pad for entering letters and digits.

Usually, when the portable telephone is folded up, the portable telephone is locked and cannot be operated unless an unlock number is entered; however, when an incoming call arrives, the call can be answered without entering the unlock number. When an incoming call arrives, in the prior art the caller's picture or the like registered in the address book is displayed on the display screen upon pressing the answer button, but according to the embodiment of the present invention, if the telephone is preset to the privacy mode by operating the selector button 23, the caller's picture, etc. will not be displayed even when the incoming call is answered.

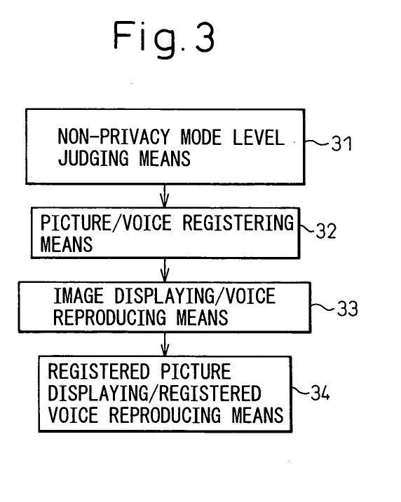

FIG. 3 is a block diagram showing the configuration of a privacy protection terminal device according to another embodiment of the present invention.

In the figure, the privacy protection terminal device comprises: a means 33 for preregistering at least either a picture or voice associated with at least either an individual or an organization registered in an address book in a terminal equipped with a function that enables the terminal to be switched between a privacy mode and a non-privacy mode; a means 33 which, when a call arrives at the terminal in the privacy mode, performs processing at least either to display an image or to reproduce voice with which the caller cannot be identified, instead of displaying the picture or reproducing the voice registered in the address book; and a means 34 which, when a call arrives at the terminal in the non-privacy mode, performs processing at least either to display the picture or to reproduce the voice registered in the address book. This privacy protection terminal device is mounted, for example, in a portable telephone.

In an alternative embodiment of the present invention, the privacy protection device may further includes a means for determining, in the case of the non-privacy mode, at which of at least two levels the non-privacy mode is. In this case, the image displaying/voice reproducing means 33 performs processing at least either to display the picture or to reproduce the voice preregistered in the address book in accordance with the determined level of the non-privacy mode.

The above embodiments have been described for the case where the portable telephone, a wireless mobile terminal, is used as the terminal, but the present invention is not limited in application to this particular type of terminal, but a wired telephone or a personal computer may be used as the terminal.

### INDUSTRIAL APPLICABILITY

According to the present invention, there is provided a privacy protection method for a terminal subscriber, a privacy protection terminal device, and a privacy protection program, wherein provisions are made to protect the privacy of the terminal subscriber by equipping the terminal with a privacy mode and a non-privacy mode and by allowing pictures, etc. stored in the address book to be displayed at the time of call arrival only in the non-privacy mode, while in the privacy mode, preventing the pictures, etc. prestored in the terminal from being unrestrictedly presented for display for viewing by other persons.

What is claimed is:

1. A privacy protection method for a terminal subscriber, comprising:
preregistering at least either a picture or voice associated with at least either an individual or an organization registered in an address book in a terminal equipped with a function that enables said terminal to be switched between a privacy mode and a non-privacy mode;
when a call arrives at said terminal in said privacy mode, performing processing at least either to display an image or to reproduce voice with which a caller cannot be identified, instead of displaying said picture or reproducing said voice registered in said address book; and
when a call arrives at said terminal in said non-privacy mode, performing processing at least either to display said picture or to reproduce said voice registered in said address book.

2. A privacy protection method as claimed in claim 1, further comprising:
determining, in the case of said non-privacy mode, at which of at least two levels said non-privacy mode is; and
performing processing at least either to display said picture or to reproduce said voice preregistered in said address book in accordance with said determined level of said non-privacy mode.

3. A privacy protection method as claimed in claim 1, wherein said registered picture is either a logo mark or a picture identifying said registered individual or organization, and said registered voice is either voice or music associated with said registered individual or organization.

4. A privacy protection terminal device for a terminal subscriber, comprising:
a unit preregistering at least either a picture or voice associated with at least either an individual or an organization registered in an address book in a terminal equipped with a function that enables said terminal to be switched between a privacy mode and a non-privacy mode;
a unit which, when a call arrives at said terminal in said privacy mode, performs processing at least either to display an image or to reproduce voice with which a caller cannot be identified, instead of displaying said picture or reproducing said voice registered in said address book; and
a unit which, when a call arrives at said terminal in said non-privacy mode, performs processing at least either to display said picture or to reproduce said voice registered in said address book.

5. A privacy protection terminal device as claimed in claim 4, further comprising:
a unit determining, in the case of said non-privacy mode, at which of at least two levels said non-privacy mode is; and
a unit performing processing at least either to display said picture or to reproduce said voice preregistered in said address book in accordance with said determined level of said non-privacy mode.

6. A privacy protection program for a terminal subscriber for causing a computer to carry out the steps of:
preregistering at least either a picture or voice associated with at least either an individual or an organization registered in an address book in a terminal equipped with a function that enables said terminal to be switched between a privacy mode and a non-privacy mode;
when a call arrives at said terminal in said privacy mode, performing processing at least either to display an image or to reproduce voice with which a caller cannot be identified, instead of displaying said picture or reproducing said voice registered in said address book; and
when a call arrives at said terminal in said non-privacy mode, performing processing at least either to display said picture or to reproduce said voice registered in said address book.
